(19) United States
(12) Patent Application Publication
(10) Pub. No.: US 2015/0033189 A1
(43) Pub. Date: Jan. 29, 2015

(54) METHODS AND SYSTEMS OF SPIRAL NAVIGATION

(71) Applicants: Marco Sachs, St. Leon-Rot (DE); Mahsa Fischer, Wiesloch (DE)

(72) Inventors: Marco Sachs, St. Leon-Rot (DE); Mahsa Fischer, Wiesloch (DE)

(73) Assignee: SAP AG, Walldorf (DE)

(21) Appl. No.: 13/951,141

(22) Filed: Jul. 25, 2013

(51) Int. Cl. G06F 3/0482; G06F 3/0485

(52) U.S. Cl. CPC G06F 3/0482; G06F 3/0485
USPC 715/830

(57) ABSTRACT

Methods and systems of navigating through process steps of a guided procedure are described. A plurality of process step identifiers may be caused to be displayed in a spiral formation in a graphical user interface of a device. Each process step identifier may identify a corresponding process step of a guided procedure. The process step identifiers may be displayed in positions along the spiral formation that reflect an order of their corresponding process steps in the guided procedure. User input may be received for one of the process steps of the guided procedure using the process step identifier that corresponds to the one of the process steps for which the user input is received. The plurality of process step identifiers may be caused to be rotated within the graphical user interface of the device.

### TECHNICAL FIELD

The present application relates generally to the technical field of data processing, and, in various embodiments, to methods and systems of navigating through process steps of a guided procedure.

### BACKGROUND

Current user interface navigation techniques suffer from several deficiencies. Such deficiencies include failing to consider or present a process flow of a guided procedure, failing to provide an overview of all of the stages of a guided procedure, poor visualization, and an excessive consumption of space.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with an example embodiment;

FIG. 2 is a block diagram illustrating enterprise applications and services in an enterprise application platform, in accordance with an example embodiment;

FIG. 3 is a block diagram illustrating a spiral navigation system, in accordance with an example embodiment;

FIGS. 4A-4K illustrate a graphical user interface at different stages of spiral navigation, in accordance with example embodiments;

FIG. 5 illustrates a graphical user in which a user interface element is integrated into a process step identifier to receive user input, in accordance with example embodiments;

FIG. 6 illustrates a graphical user interface in which an indication of received user input for a process step is displayed in a central location around which the spiral formation of the process step identifiers is disposed, in accordance with example embodiments;

FIG. 7 is a flowchart illustrating a method of spiral navigation, in accordance with an example embodiment; and

FIG. 8 is a block diagram of an example computer system on which methodologies described herein may be executed, in accordance with an example embodiment.

### DETAILED DESCRIPTION

Example methods and systems of navigating through process steps of a guided procedure are described. In the following description, for purposes of explanation, numerous specific details are set forth in order to provide a thorough understanding of example embodiments. It will be evident, however, to one skilled in the art that the present embodiments may be practiced without these specific details.

The spiral navigation techniques of the present disclosure provide a more usable navigation experience, with improved look, feel, and guidance for the user. The spiral navigation techniques also provide an efficient use of space.

In some embodiments, a method may comprise causing, by a machine having a memory and a processor, a plurality of process step identifiers to be displayed in a spiral formation in a graphical user interface of a device. Each process step identifier may identify a corresponding process step of a guided procedure. The process step identifiers may be displayed in positions along the spiral formation that reflect an order of their corresponding process steps in the guided procedure. User input may be received for one of the process steps of the guided procedure using the process step identifier that corresponds to the one of the process steps for which the user input is received. The plurality of process step identifiers may be caused to be rotated within the graphical user interface of the device.

In some embodiments, the plurality of process step identifiers may comprise a corresponding process step identifier for every process step in the guided procedure that requires user input in order for the guided procedure to be completed. In some embodiments, the process step identifiers may be connected by at least one graphical element forming a spiral path.

In some embodiments, the method may further comprise adjusting the corresponding process step identifier to include an indication of the received user input for the one of the process steps. In some embodiments, the indication may comprise a summary of the received user input. In some embodiments, the method may further comprise causing an indication of the received user input for the one of the process steps to be displayed in a central location around which the spiral formation of the process step identifiers is disposed.

In some embodiments, receiving user input for one of the process steps may comprise: receiving a user selection of the process step identifier corresponding to the one of the process steps; causing a user interface element to be displayed, wherein the user interface element is separate from the corresponding process step identifier and is configured to receive user input for the one of the process steps; and receiving the user input via the user interface element. In some embodiments, the user interface element may be displayed on a separate page as the corresponding process step identifier. In some embodiments, receiving user input for one of the process steps may comprise receiving the user input via a user interface element integrated into the corresponding process step identifier.

In some embodiments, the plurality of process step identifiers may be caused to be rotated in response to a rotation indication from the user, the rotation indication may indicate a desire to rotate the plurality of process step identifiers. In some embodiments, each process step identifier may comprise a card.

In some embodiments, a system may comprise a machine and a spiral navigation module on the machine. The machine may have a memory and at least one processor. The spiral navigation module may be configured to cause a plurality of process step identifiers to be displayed in a spiral formation in a graphical user interface of a device. Each process step identifier may identify a corresponding process step of a guided procedure. The process step identifiers may be displayed in positions along the spiral formation that reflect an order of their corresponding process steps in the guided procedure. The spiral navigation module may be further configured to receive user input for one of the process steps of the guided procedure using the process step identifier that corresponds to the one of the process steps for which the user input is received, and cause the plurality of process step identifiers to be rotated within the graphical user interface of the device.

In some embodiments, the plurality of process step identifiers may comprise a corresponding process step identifier for every process step in the guided procedure that requires user input in order for the guided procedure to be completed. In some embodiments, the process step identifiers may be connected by at least one graphical element forming a spiral path.

In some embodiments, the spiral navigation module may be further configured to adjust the corresponding process step identifier to include an indication of the received user input for the one of the process steps. In some embodiments, the indication may comprise a summary of the received user input. In some embodiments, the spiral navigation module may be further configured to cause an indication of the received user input for the one of the process steps to be displayed in a central location around which the spiral formation of the process step identifiers is disposed.

In some embodiments, the spiral navigation module may be further configured to: receive a user selection of the process step identifier corresponding to the one of the process steps; cause a user interface element to be displayed, wherein the user interface element is separate from the corresponding process step identifier and is configured to receive user input for the one of the process steps; and receive the user input via the user interface element. In some embodiments, the spiral navigation module may be configured to cause the user interface element to be displayed on a separate page as the corresponding process step identifier. In some embodiments, the spiral navigation module may be further configured to receive the user input for one of the process steps via a user interface element integrated into the corresponding process step identifier.

In some embodiments, the plurality of process step identifiers may be caused to be rotated in response to a rotation indication from the user, the rotation indication may indicate a desire to rotate the plurality of process step identifiers. In some embodiments, each process step identifier may comprise a card.

In some embodiments, a non-transitory machine-readable storage device may store a set of instructions that, when executed by at least one processor, causes the at least one processor to perform the operations and method steps discussed within the present disclosure.

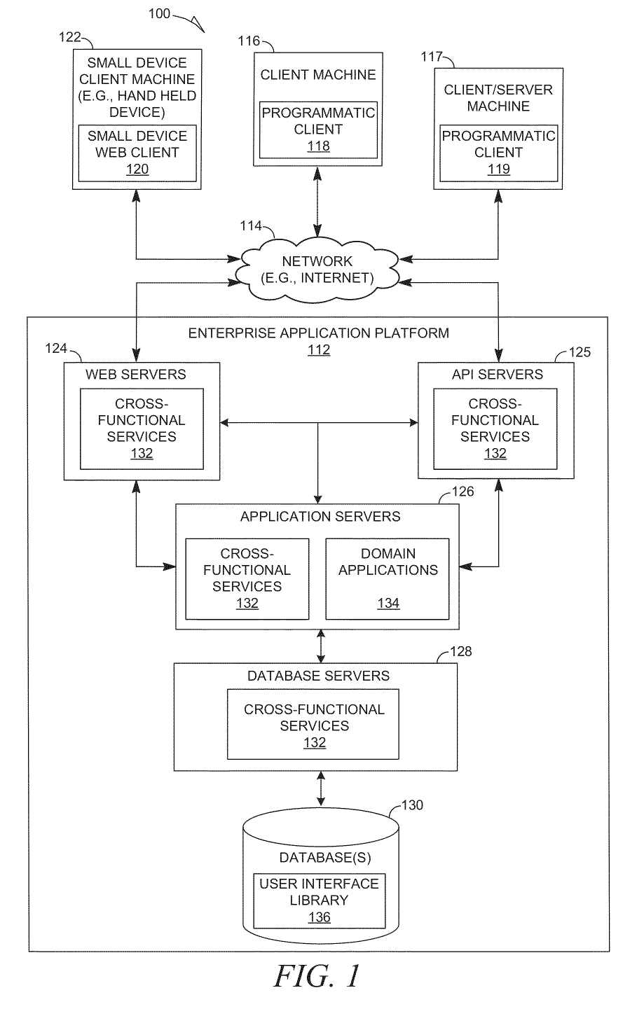

FIG. 1 is a network diagram illustrating a client-server system, in accordance with an example embodiment. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser, such as the INTERNET EXPLORER browser developed by Microsoft Corporation of Redmond, Wash. State), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 may be coupled to, and provide web and programmatic interfaces to, application servers 126. The application servers 126 may be, in turn, coupled to one or more database servers 128 that facilitate access to one or more databases 130. The web servers 124, Application Program Interface (API) servers 125, application servers 126, and database servers 128 may host cross-functional services 132. The application servers 126 may further host domain applications 134.

The cross-functional services 132 provide services to users and processes that utilize the enterprise application platform 112. For instance, the cross-functional services 132 may provide portal services (e.g., web services), database services, and connectivity to the domain applications 134 for users that operate the client machine 116, the client/server machine 117 and the small device client machine 122. In addition, the cross-functional services 132 may provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are, of course, not limited to such an architecture, and could equally well find application in a distributed, or peer-to-peer, architecture system.

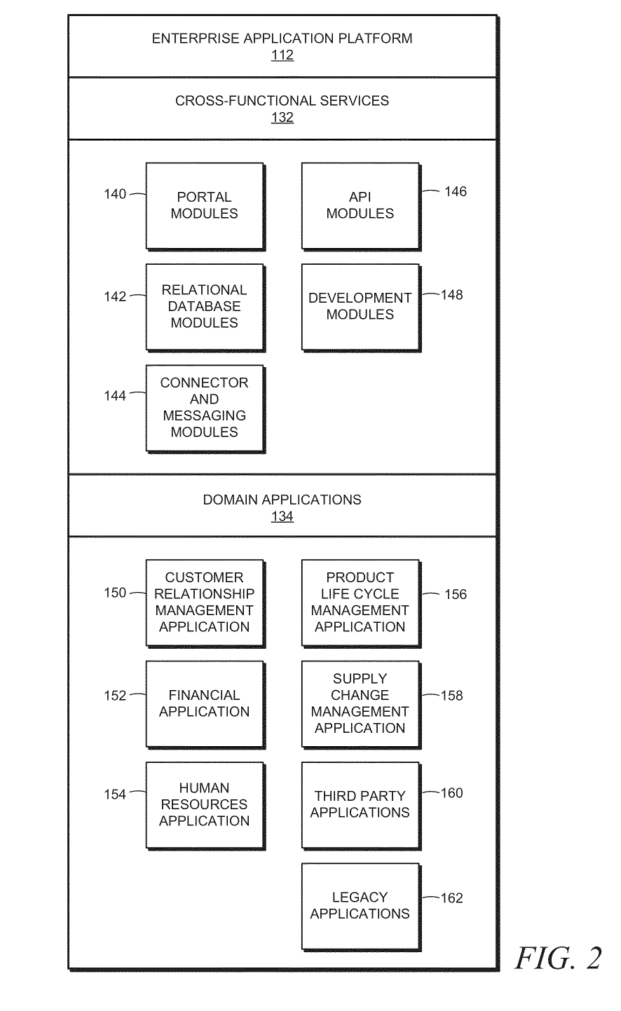

FIG. 2 is a block diagram illustrating enterprise applications and services in an enterprise application platform 112, in accordance with an example embodiment. The enterprise application platform 112 includes cross-functional services 132 and domain applications 134. The cross-functional services 132 may include portal modules 140, relational database modules 142, connector and messaging modules 144, Application Program Interface (API) modules 146, and development modules 148.

The portal modules 140 may enable a single point of access to other cross-functional services 132 and domain applications 134 for the client machine 116, the small device client machine 122 and the client/server machine 117. The portal modules 140 may be utilized to process, author, and maintain web pages that present content (e.g., user interface elements and navigational controls) to the user. In addition, the portal modules 140 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 140 include a generation module, a communication module, a receiving module, and a regenerating module. In addition, the portal modules 140 may comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 may provide support services for access to the database(s) 130, which includes a user interface library 136. The relational database modules 142 may provide support for object relational mapping, database independence, and distributed computing. The relational database modules 142 may be utilized to add, delete, update, and manage database elements. In addition, the relational database modules 142 may comply with database standards and/or utilize a variety of database technologies including SQL, SQLDBC, Oracle, MySQL, Unicode, JDBC.

The connector and messaging modules 144 may enable communication across different types of messaging systems that are utilized by the cross-functional services 132 and the domain applications 134 by providing a common messaging application processing interface. The connector and messaging modules 144 may enable asynchronous communication on the enterprise application platform 112.

The Application Program Interface (API) modules 146 may enable the development of service-based applications by exposing an interface to existing and new applications as services. Repositories may be included in the platform as a central place to find available services when building applications.

The development modules 148 may provide a development environment for the addition, integration, updating, and extension of software components on the enterprise application platform 112 without impacting existing cross-functional services 132 and domain applications 134.

Turning to the domain applications 134, the customer relationship management application 150 may enable access to and may facilitate collecting and storing of relevant personalized information from multiple data sources and business processes. Enterprise personnel that are tasked with developing a buyer into a long-term customer may utilize the customer relationship management applications 150 to provide assistance to the buyer throughout a customer engagement cycle.

Enterprise personnel may utilize the financial applications 152 and business processes to track and control financial transactions within the enterprise application platform 112. The financial applications 152 may facilitate the execution of operational, analytical, and collaborative tasks that are associated with financial management. Specifically, the financial applications 152 may enable the performance of tasks related to financial accountability, planning, forecasting, and managing the cost of finance.

The human resource applications 154 may be utilized by enterprise personnel and business processes to manage, deploy, and track enterprise personnel. Specifically, the human resource applications 154 may enable the analysis of human resource issues and facilitate human resource decisions based on real time information.

The product life cycle management applications 156 may enable the management of a product throughout the life cycle of the product. For example, the product life cycle management applications 156 may enable collaborative engineering, custom product development, project management, asset management, and quality management among business partners.

The supply chain management applications 158 may enable monitoring of performances that are observed in supply chains. The supply chain management applications 158 may facilitate adherence to production plans and on-time delivery of products and services.

The third-party applications 160, as well as legacy applications 162, may be integrated with domain applications 134 and utilize cross-functional services 132 on the enterprise application platform 112.

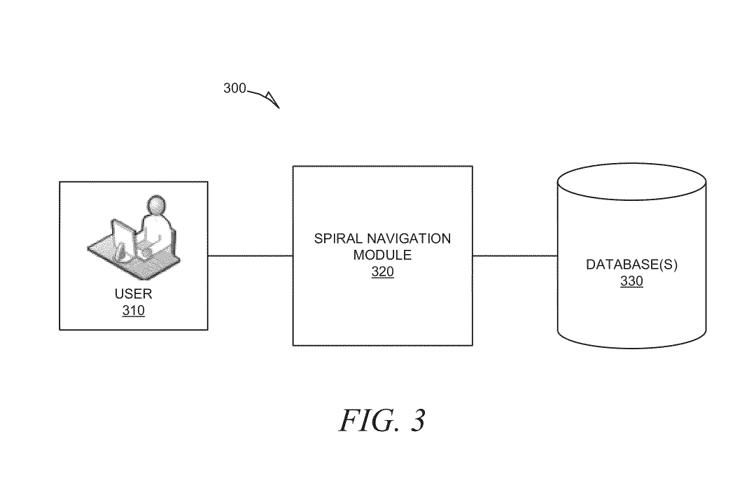

FIG. 3 is a block diagram illustrating a spiral navigation system 300, in accordance with an example embodiment. In some embodiments, the spiral navigation system 300 may comprise a spiral navigation module 320, which may reside on a machine having a memory and at least one processor (not shown). In some embodiments, the spiral navigation module 320 may be incorporated into the enterprise application platform 112 in FIG. 1 (e.g., on application server(s) 126). However, it is contemplated that other configurations are also within the scope of the present disclosure.

In some embodiments, the spiral navigation module 320 may be configured to provide a spiral navigation experience to a user 310 on a device (e.g., any of machines 116, 117, and 122 in FIG. 1). In some embodiments, the user 310 may communicate with the spiral navigation module 320 via a network (e.g., network 114 in FIG. 1). In some embodiments, the user 310 may communicate with the spiral navigation module 320 without the use of a network, such as if the spiral navigation module 320 resides on the device of the user 310.

In some embodiments, the spiral navigation module 320 may access, retrieve information from, and otherwise communicate with one or more databases 330 (e.g., database(s) 130 in FIG. 1). Database(s) 330 may provide and/or store any data generated or required by any functions being performed by the spiral navigation module 320.

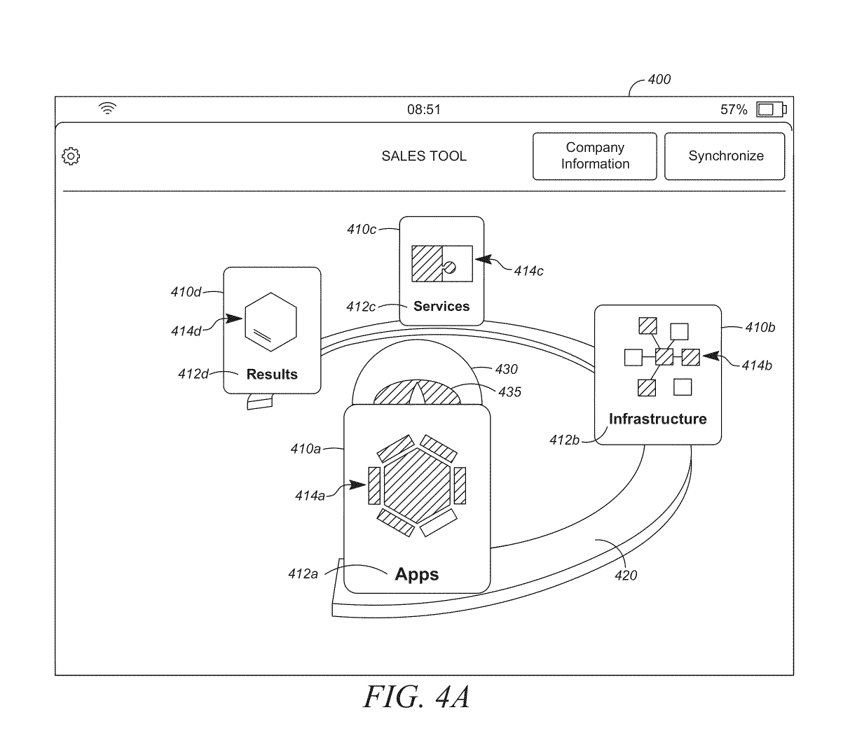

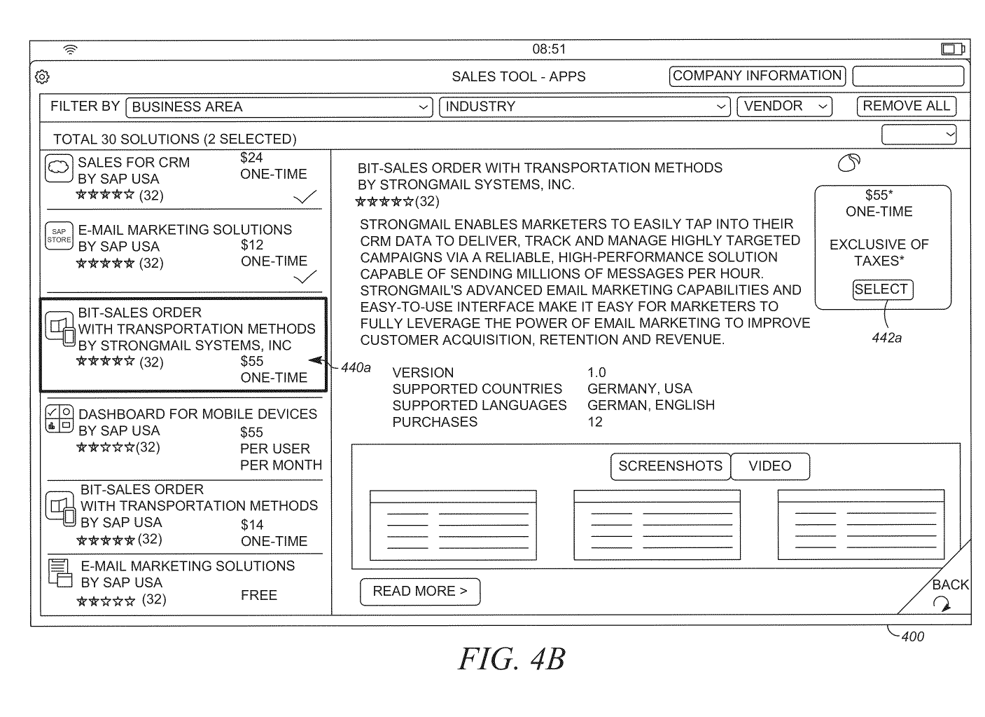

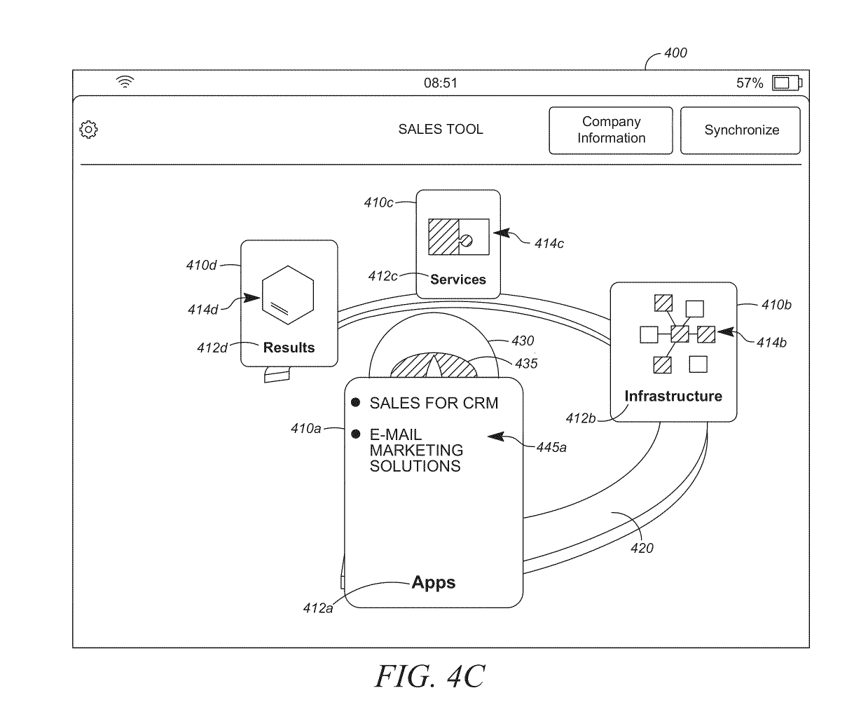

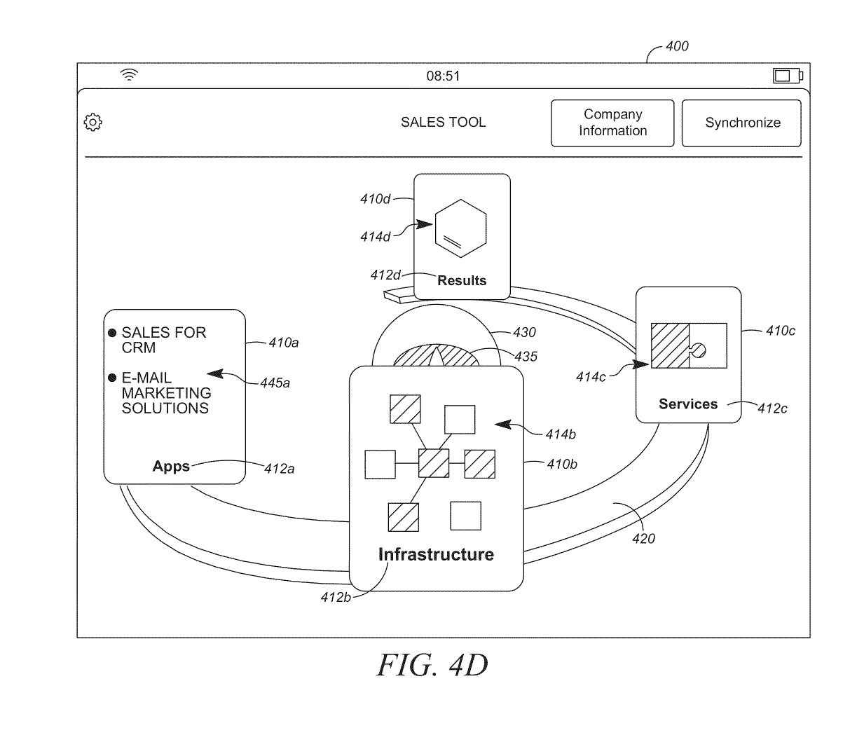

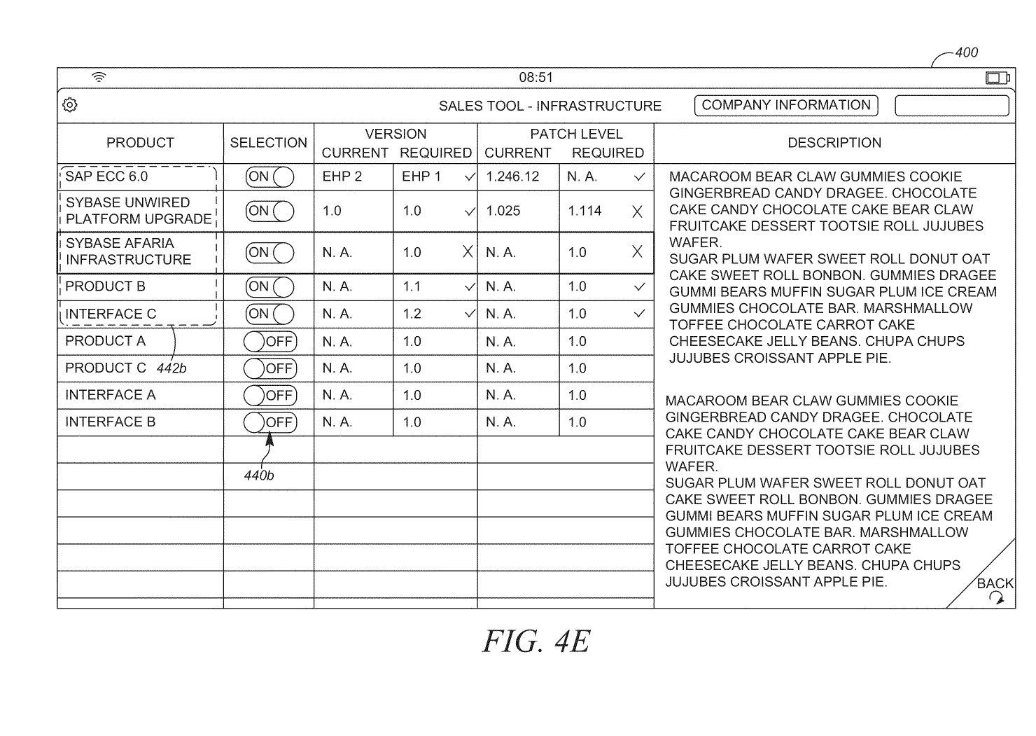

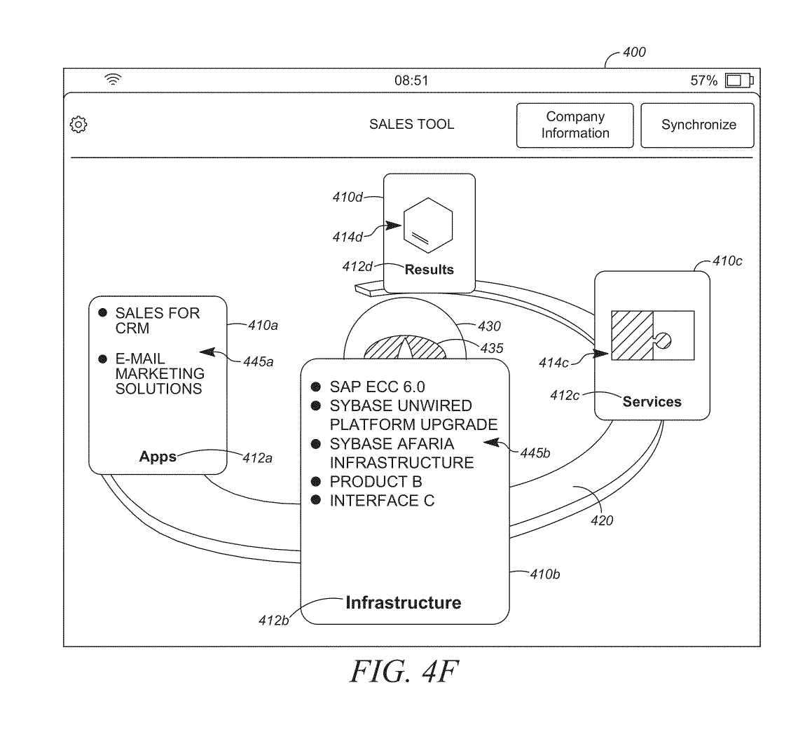

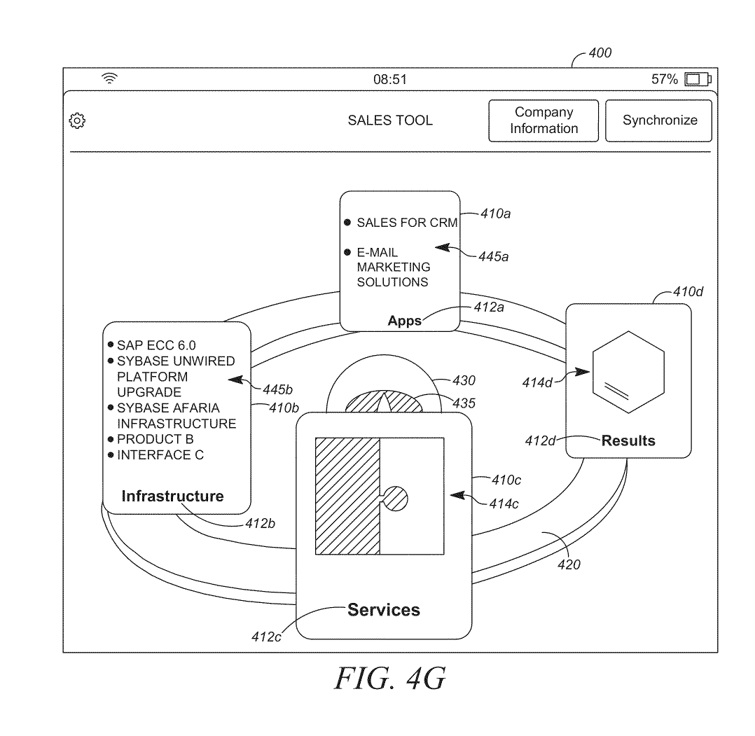

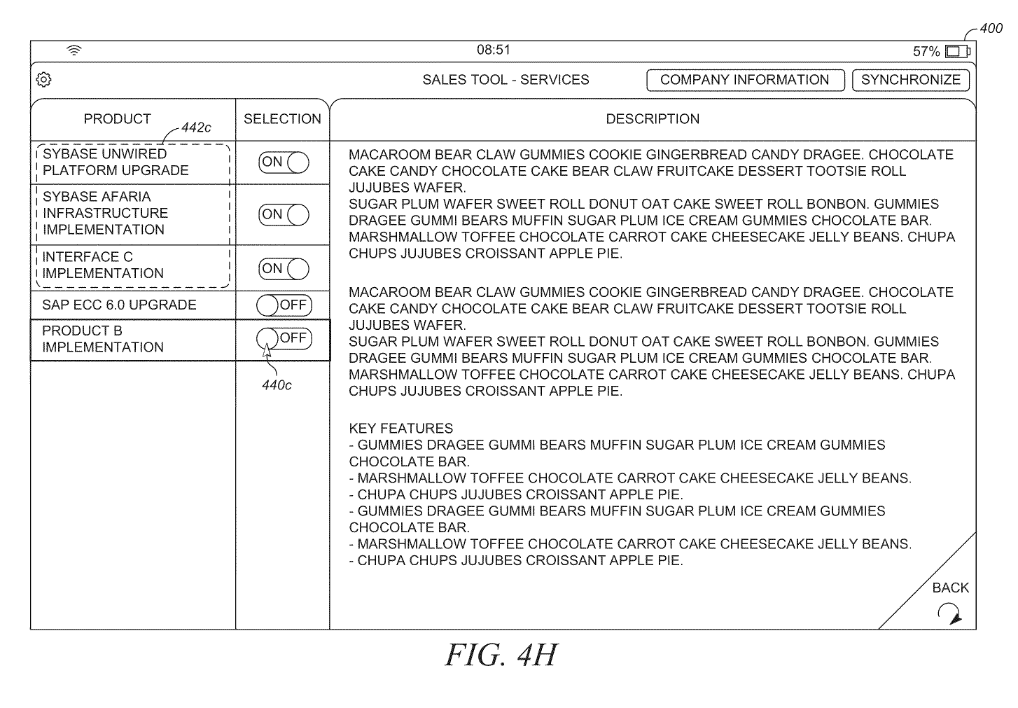

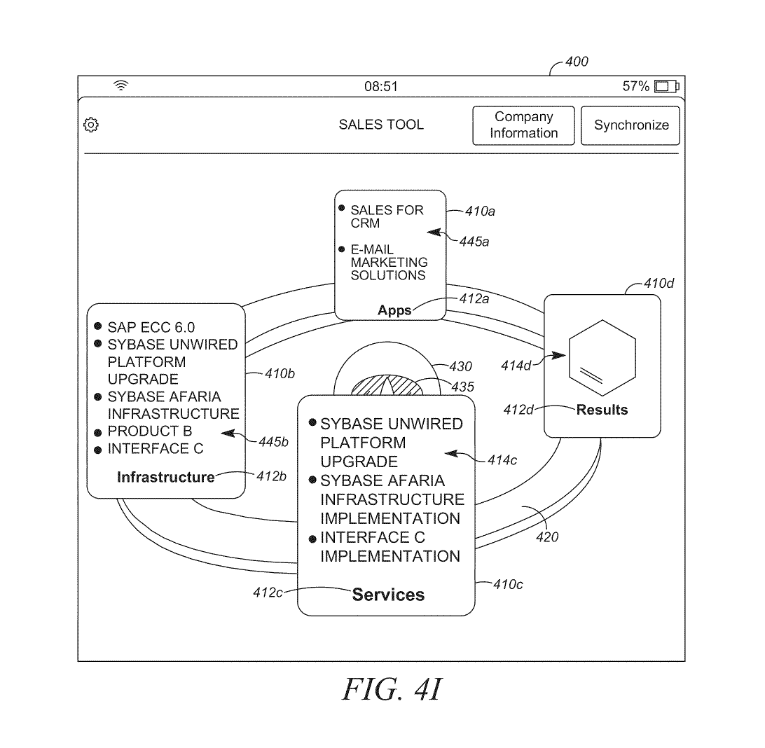

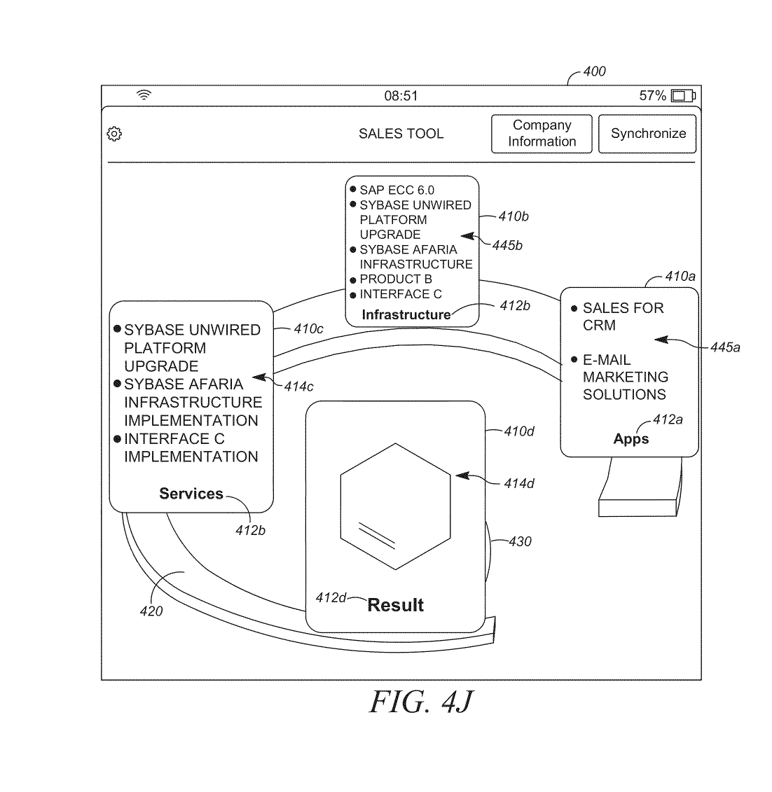

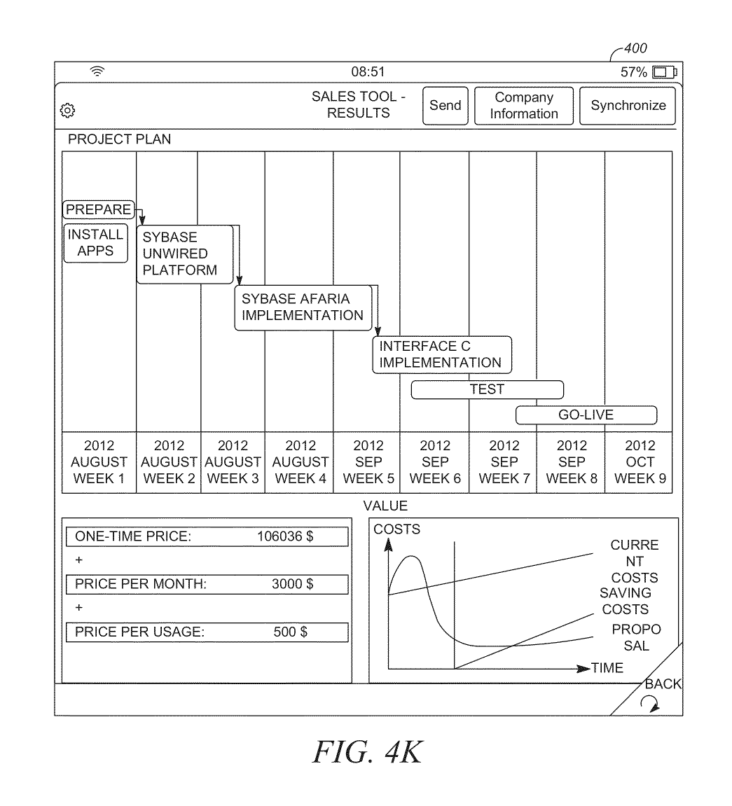

FIGS. 4A-4K illustrate a graphical user interface 400 at different stages of spiral navigation, in accordance with example embodiments. In some embodiments, the spiral navigation module 320 may be configured to cause a plurality of process step identifiers 410a, 410b, 410c, and 410d to be displayed in a spiral formation in the graphical user interface 400. In some embodiments, each process step identifier 410a-410d may comprise a card. However, it is contemplated that other forms of the process step identifiers 410a-410d are also within the scope of the present disclosure.

Each process step identifier 410a-410d may identify a corresponding process step of a guided procedure. Such identification may be achieved in a variety of ways. In some embodiments, the process step identifiers 410a-410d may comprise descriptive text 412a-412d, respectively, providing an indication of the corresponding process step in the guided procedure. In some embodiments, the process step identifiers 410a-410d may comprise graphical objects 414a-414d, respectively, providing an indication of the corresponding process step.

The process step identifiers 410a-410d may be displayed in positions along the spiral formation that reflect an order of their corresponding process steps in the guided procedure. Whichever process step identifier 410a-401d that corresponds to the current step in the guided procedure may be displayed as being in the forefront (e.g., it may appear closer to the user than any of the other process step identifiers), or otherwise prominently displayed in a fashion that makes it the focus of the user 310. In some embodiments, the process step identifiers may be connected by at least one graphical element forming a spiral path 420. It is contemplated that the spiral path 420 may be formed from a continuous graphical element, a segmented graphical element, and multiple graphical elements, as well as other graphical element configurations not explicitly disclosed herein.

In some embodiments, the plurality of process step identifiers 410a-410d may comprise a corresponding process step identifier for every process step in the guided procedure that requires user input in order for the guided procedure to be completed. However, it is contemplated that some process step identifiers may correspond to process steps that do not require user input in order for the guided procedure to be completed. For example, a process step identifier 410d may correspond to a process step that shows results of the guided procedure, without any need for user input for that process step.

A guided procedure may be any procedure that guides a user 310 through its steps from beginning to end, providing the user 310 with the ability to provide input along the way that is necessary for completion of the procedural goal. One example of a guided procedure may be an e-commerce checkout procedure for purchasing an item, which may include steps of selecting one or more items to buy, providing payment information, providing a billing address, providing a shipping address, selecting shipping options, and confirming the purchase of the item(s). It is contemplated that other types of guided procedures are also within the scope of the present disclosure.

The spiral navigation module 320 may be configured to receive user input for the process steps of the guided procedure using the corresponding process step identifiers 410a-410d. In some embodiments, the spiral navigation module 320 may be configured to receive a user selection of one of the process step identifiers 410a-410d corresponding to the one of the process steps. For example, the user 310 may click, tap, or otherwise select one of the process step identifiers 410a-410d. In response to the selection of one of the process step identifiers 410a-410d by the user 310, the spiral navigation module 320 may cause a user interface element to be displayed. In some embodiments, the user interface element may be separate from the corresponding process step identifier 410a-410d. In some embodiments, the user interface element may be integrated into the corresponding process step identifier 410a-410d.

Referring to the example provided in FIG. 4A, the guided procedure may comprise four steps: (1) selection of applications (corresponding to process step identifier 410a labeled “Apps”); (2) selection of infrastructure (corresponding to process step identifier 410b labeled “Infrastructure”); (3) selection of services (corresponding to process step identifier 410c labeled “Services”); and (4) viewing of the results of the selections of the first three steps (corresponding to process step identifier 410d labeled “Results”). The corresponding process step identifiers 410a-410d of these four steps are positioned along the spiral path 420 in positions that reflect their order in the guided procedure. Accordingly, process step identifier 410a, which corresponds to the selection of applications, is positioned at the beginning of the spiral path 420.

In response to the user 310 selecting process step identifier 410a, the spiral navigation module 320 may present the user 310 with one or more user interface elements in order to enable the user 310 to select applications for the corresponding process step. These user interface elements may be presented to the user 310 as being separated from the process step identifier 410a. In some embodiments, these user interface elements may be displayed on a separate page as the process step identifier 410a. In FIG. 4B, an example is provided of the user interface elements being displayed on a separate page as the process step identifier 410a. Here, the user 310 may select any of the applications 440a listed on the left side of the user interface 400 to view details about them, and then select a “Select” button 442a in order to confirm the selection of the application currently being viewed. In the example provided in FIG. 4B, The user 310 has selected “Sales for CRM” and “E-Mail Marketing Solutions” as the applications for this step of the guided procedure, as reflected by the check marks next to these applications on the left side of the user interface 400.

In some embodiments, the spiral navigation module 320 may be further configured to adjust the corresponding process step identifier 410a-410d to include an indication of the received user input for the corresponding process step. In some embodiments, the indication may comprise a summary of the received user input. For example, in FIG. 4C, in response to the user 310 selecting the applications in FIG. 4B, the spiral navigation module 320 may adjust process step identifier 410a to include an indication 445a of the selection of these applications (“Sales for CRM” and “E-Mail Marketing Solutions”).

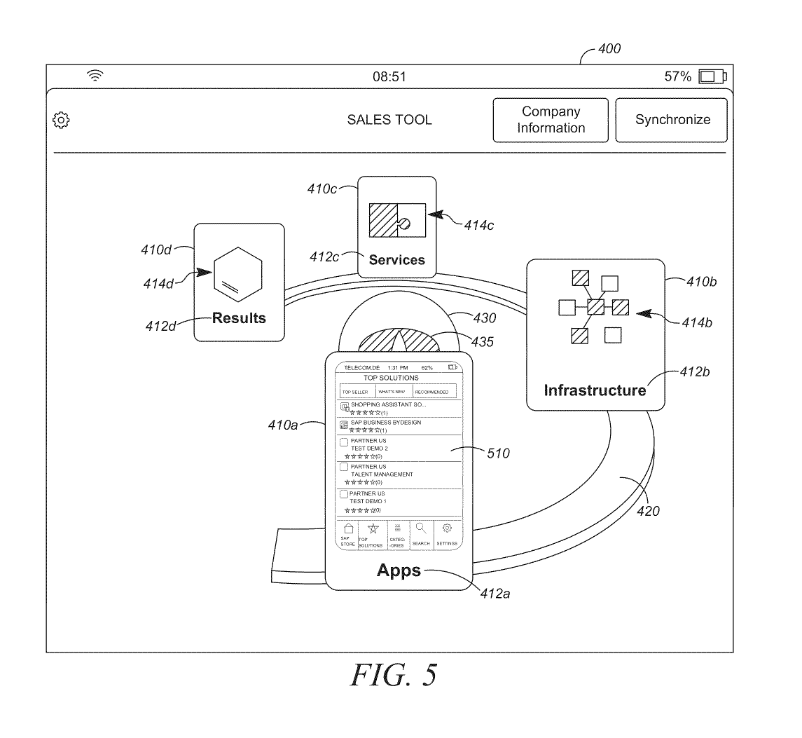

In some embodiments, the spiral navigation module 320 may be configured to enable the user 310 to provide user input for a process step by using a user interface element integrated into the corresponding process step identifier. FIG. 5 illustrates a graphical user interface 400 in which a user interface element 510 is integrated into process step identifier 410a to receive user input, in accordance with example embodiments. In this example, the user 310 may provide input for the process step without leaving the page on which the spiral formation of process step identifiers 410a-410d is being displayed. For example, the user 310 may select one or more applications for this process step directly from process step identifier 410a. User interface element 510 may include, but is not limited to, text boxes, selectable buttons, drop-down lists, check boxes, and sliders. It is contemplated that other user interface elements are also within the scope of the present disclosure.

The spiral navigation module 320 may be configured to cause the plurality of process step identifiers 410a-410d to be rotated within the graphical user interface 400 of the device. For example, in FIG. 4D, the process step identifiers 410a-410d have been rotated, with process step identifier 410b being brought to the forefront and process step identifier 410a moving away from the forefront. In some embodiments, the plurality of process step identifiers may be caused to be rotated in response to a rotation indication from the user 310. The rotation indication may indicate a desire to rotate the plurality of process step identifiers 410a-410d. For example, the user 310 may swipe the screen of the device in a direction of the desired rotation. It is contemplated that other rotation indications are also within the scope of the present disclosure. In some embodiments, the spiral navigation module 320 may automatically cause the process step identifiers 410a-410d to rotate in response to the user 310 providing user input for a process step (e.g., if the required input for the process step has been received).

The spiral formation of process step identifiers 410a-410d may be disposed around a central location. In some embodiments, a central graphical object 430 may be displayed in this central location. This central graphical object 430 may comprise a circular shape, thereby helping the user 310 visualize the rotation of the process step identifiers 410a-410d. However, it is contemplated that other forms and shapes of the central graphical object 430 are also within the scope of the present disclosure. In some embodiments, the central graphical object 430 may comprise a logo 435 of a company.

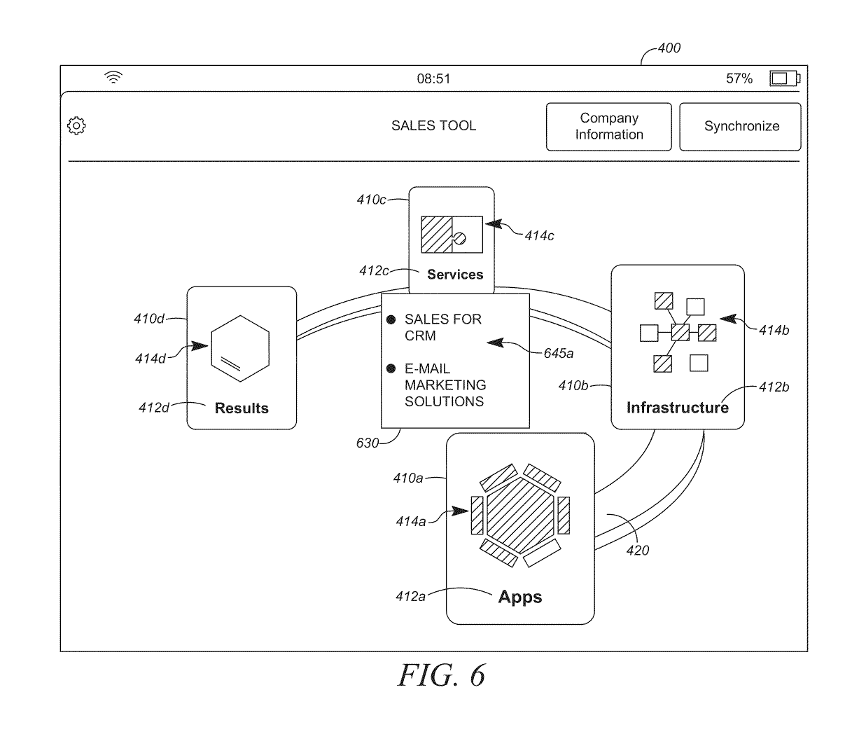

In some embodiments, the spiral navigation module 320 may be configured to cause an indication of the received user input for the one of the process steps to be displayed in the central location around which the spiral formation of the process step identifiers 410a-410d is disposed. FIG. 6 illustrates a graphical user interface 400 in which an indication 645a of received user input for a process step is displayed in a central location 630 around which the spiral formation of the process step identifiers is disposed, in accordance with example embodiments. This indication 645a of received user input may be displayed in addition to or as an alternative to the indications 445a-445c of user input on the process step identifiers 410a-410c, respectively.

The display of indications of received user input in a central location around which the process step identifiers 410a-410d rotate may help provide the user 310 with an overview of the results of the guided procedure. For example, in a scenario where the guided procedure is selecting options for an automobile, as the user 310 provides input at each process step, this input may be reflected in the central location. For example, as a result of the user 310 selecting a make and model for the automobile (e.g., Audi A4) in the first step, the body of the automobile may be displayed in the central location. As a result of the user 310 selecting an exterior color (e.g., silver) in the second step, the body of the automobile in the central location may be adjusted to reflect that color (e.g., the automobile will appear silver). The user 310 may continue to make selections for the other process steps in the guided procedure for the automobile, with these selections being reflected on the automobile displayed in the central location.

Referring back to FIG. 4D, the user 310 may then provide an indication that he or she wants to provide input for the process step corresponding to process step identifier 410b. Such indication may include, but is not limited to, clicking or tapping on process step identifier 410b. It is contemplated that other forms of providing this indication are also within the scope of the present disclosure.

The spiral navigation module 320 may then provide the user 310 with one or more user interface elements to enable the user to provide input for the corresponding process step. In FIG. 4E, the spiral navigation module 320 displays selection options for infrastructure on a separate page as the process step identifiers. Although, it is contemplated that these user interface elements may be presented on the same page as process step identifiers 410a-410d or integrated with the corresponding process step identifier 410b. In the example provided in FIG. 4E, the user 310 may select an infrastructure product using user interface elements 440b. The selected infrastructure products in FIG. 4E are shown within the dotted line 442b.

In FIG. 4F, upon returning the user 310 to the page with the process step identifiers 410a-410d, the spiral navigation module 320 may adjust process step identifier 410b to include an indication 445b of the selected infrastructure products 442b in FIG. 4E. In the example provided in FIG. 4F, this indication 445b comprises a summary of the selected infrastructure products (SAP ECC 6.0, Sybase Unwired Platform Upgrade, Sybase Afaria Infrastructure, Product B, Interface C).

The user 310 may then swipe the screen or provide some other indication to rotate the process step identifiers 410a-410d in order to move to the next process step in the guided procedure. In FIG. 4G, the spiral navigation module 320 has rotated the process step identifiers 410a-410d so that process step identifier 410c has been moved to the forefront. The user 310 may then select process step identifier 410c to indicate that he or she wants to provide input for the corresponding process step, which, in this example, is selecting services products.

The spiral navigation module 320 may then provide the user 310 with one or more user interface elements to enable the user to provide input for the corresponding process step. In FIG. 4H, the spiral navigation module 320 displays selection options for services on a separate page as the process step identifiers 410a-410d. Although, it is contemplated that these user interface elements may be presented on the same page as process step identifiers 410a-410d or integrated with the corresponding process step identifier 410c. In the example provided in FIG. 4H, the user 310 may select a services product using user interface elements 440c. The selected services products in FIG. 4H are shown within the dotted line 442c.

In FIG. 4I, upon returning the user 310 to the page with the process step identifiers 410a-410d, the spiral navigation module 320 may adjust process step identifier 410c to include an indication 445c of the selected infrastructure products 442c in FIG. 4H. In the example provided in FIG. 4I, this indication 445c comprises a summary of the selected services products (Sybase Unwired Platform Upgrade, Sybase Afaria Infrastructure Implementation, Interface C Implementation).

The user 310 may then swipe the screen or provide some other indication to rotate the process step identifiers 410a-410d in order to move to the next process step in the guided procedure. In FIG. 4J, the spiral navigation module 320 has rotated the process step identifiers 410a-410d so that process step identifier 410d has been moved to the forefront. In this example, process step identifier 410d corresponds to the process step of viewing results of the user input provided for the guided procedure. The user 310 may then select process step identifier 410d to indicate that he or she wants to view the results. In FIG. 4K, the results are displayed to the user 310. The results may include the effects of the choices the user 310 made in the previous process steps.

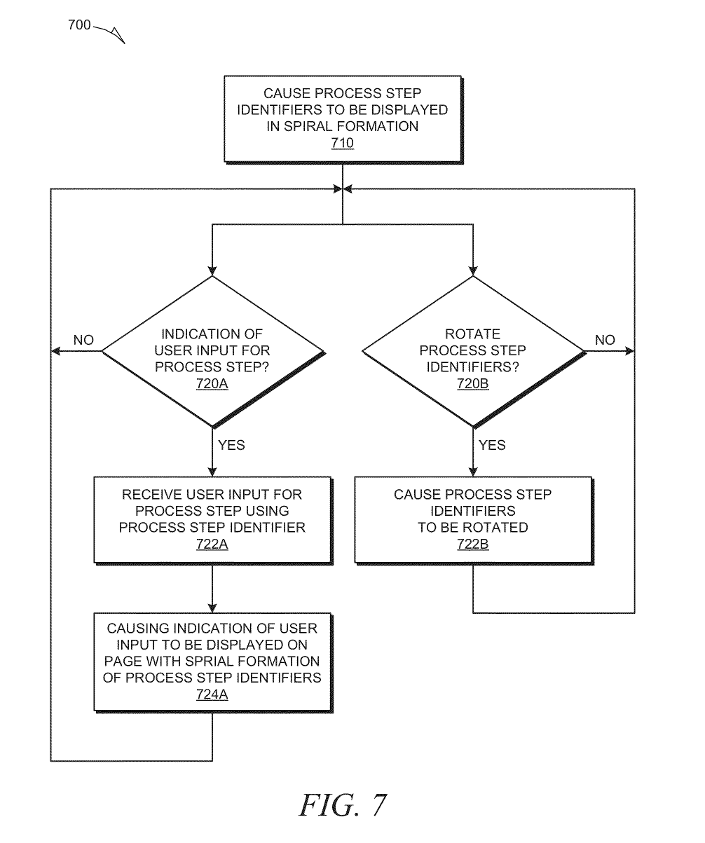

FIG. 7 is a flowchart illustrating a method 700 of spiral navigation, in accordance with an example embodiment. In an example embodiment, the operations of method 700 may be performed by a system or modules of a system (e.g., spiral navigation module 320 in FIG. 3).

At operation 710, process step identifiers may be caused to be displayed in a spiral formation in a graphical user interface of a device. As previously discussed, each process step identifier may identify a corresponding process step of a guided procedure, and the process step identifiers may be displayed in positions along the spiral formation that reflect an order of their corresponding process steps in the guided procedure.

Two determinations may be made throughout method 700. One of the determinations may be made at operation 720A, and the other determination may be made at operation 720B. These determinations may be repeated over and over, and side by side, while the process step identifiers are being displayed.

At operation 720A, it may be determined whether or not an indication has been received indicating that user input for a process step is to be received. Such indication may include, but is not limited to, the user selecting a process step identifier or interacting with a user interface element configured to enable selection of an option for a process step.

If such an indication has been received, then, at operation 722A, user input for a process step is received using the corresponding process step identifier. In some embodiments, the user input may be received via one or more user interface elements on a separate page as the process step identifiers. In some embodiments, the user input may be received via one or more user interface elements integrated with the corresponding process step identifier. It is contemplated that other ways of receiving the user input are also within the scope of the present disclosure.

At operation 724A, an indication of the user input may be caused to be displayed on the same page as the spiral formation of process step identifiers. In some embodiments, the corresponding process step identifier may be adjusted to include the indication of the received user input. In some embodiments, an indication of the received user input may be caused to be displayed in a central location around which the spiral formation of the process step identifiers is disposed. It is contemplated that the indication of the user input may be caused to be displayed in other ways as well. The method may then repeat the determination operations 720A and 720B.

If, at operation 720A, it is determined that there has been no indication that user input for a process step is to be received, then the method may then repeat the determination operations 720A and 720B.

At operation 720B, it is determined whether or not the process step identifiers should be rotated. In some embodiments, if a rotation indication (e.g., a swipe of the screen in the direction of the desired rotation) is received from the user, then it may be determined that the process step identifiers should be rotated. In some embodiments, it may be determined that automatic rotation (e.g., without a user initiated rotation indication) should be performed in response to the user providing user input for a process step (e.g., if the required input for the process step has been received).

If, at operation 720B, it is determined that the process step identifiers should be rotated, then, at operation 722B, the process step identifiers may be rotated. The method may then repeat the determination operations 720A and 720B.

If at operation 720B, it is determined that the process step identifiers should not be rotated, then the method may then repeat the determination operations 720A and 720B.

It is contemplated that any of the other features described within the present disclosure may be incorporated into method 700.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

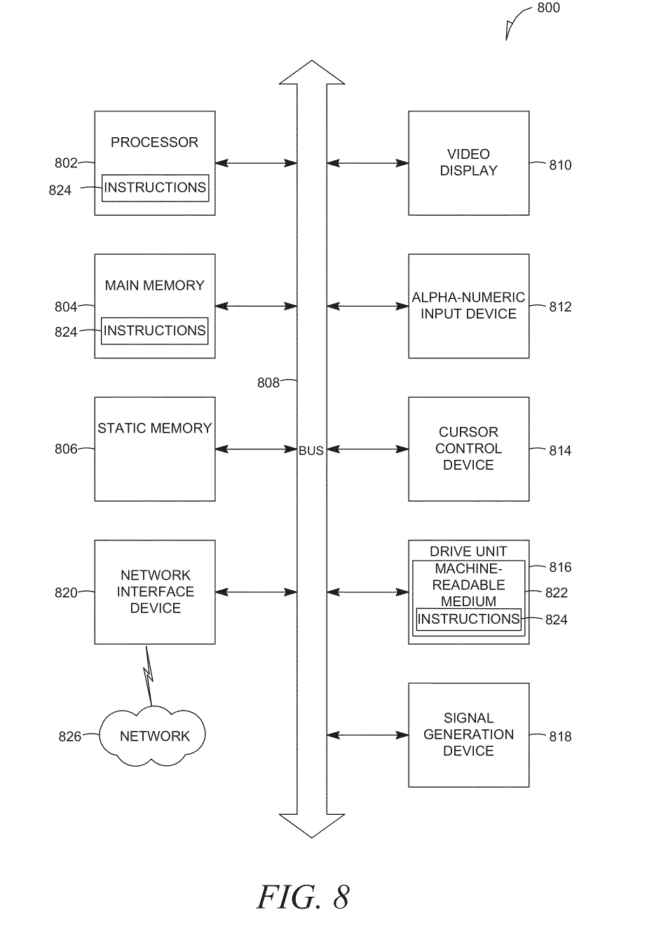

FIG. 8 is a block diagram of a machine in the example form of a computer system 800 within which instructions 824 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
causing, by a machine having a memory and a processor, a plurality of process step identifiers to be displayed in a spiral formation in a graphical user interface of a device, each process step identifier identifying a corresponding process step of a guided procedure, the process step identifiers being displayed in positions along the spiral formation that reflect an order of their corresponding process steps in the guided procedure;
receiving a user input for one of the process steps of the guided procedure using the process step identifier that corresponds to the one of the process steps for which the user input is received; and
causing the plurality of process step identifiers to be rotated within the graphical user interface of the device.

2. The method of claim 1, wherein the plurality of process step identifiers comprises a corresponding process step identifier for every process step in the guided procedure that requires user input in order for the guided procedure to be completed.

3. The method of claim 1, wherein the process step identifiers are connected by at least one graphical element forming a spiral path.

4. The method of claim 1, further comprising adjusting the corresponding process step identifier to include an indication of the received user input for the one of the process steps.

5. The method of claim 4, wherein the indication comprises a summary of the received user input.

6. The method of claim 1, further comprising causing an indication of the received user input for the one of the process steps to be displayed in a central location around which the spiral formation of the process step identifiers is disposed.

7. The method of claim 1, wherein receiving user input for one of the process steps comprises:
receiving a user selection of the process step identifier corresponding to the one of the process steps;
causing a user interface element to be displayed, wherein the user interface element is separate from the corresponding process step identifier and is configured to receive user input for the one of the process steps; and
receiving the user input via the user interface element.

8. The method of claim 7, wherein the user interface element is displayed on a separate page as the corresponding process step identifier.

9. The method of claim 1, wherein receiving user input for one of the process steps comprises receiving the user input via a user interface element integrated into the corresponding process step identifier.

10. The method of claim 1, wherein the plurality of process step identifiers is caused to be rotated in response to a rotation indication from the user, the rotation indication indicating a desire to rotate the plurality of process step identifiers.

11. The method of claim 1, wherein each process step identifier comprises a card.

12. A system comprising:
a machine having a memory and at least one processor; and
a spiral navigation module on the machine, the spiral navigation module being configured to:
cause a plurality of process step identifiers to be displayed in a spiral formation in a graphical user interface of a device, each process step identifier identifying a corresponding process step of a guided procedure, the process step identifiers being displayed in positions along the spiral formation that reflect an order of their corresponding process steps in the guided procedure;
receive a user input for one of the process steps of the guided procedure using the process step identifier that corresponds to the one of the process steps for which the user input is received; and
cause the plurality of process step identifiers to be rotated within the graphical user interface of the device.

13. The system of claim 12, wherein the plurality of process step identifiers comprises a corresponding process step identifier for every process step in the guided procedure that requires user input in order for the guided procedure to be completed.

14. The system of claim 12, wherein the process step identifiers are connected by at least one graphical element forming a spiral path.

15. The system of claim 12, wherein the spiral navigation module is further configured to adjust the corresponding process step identifier to include an indication of the received user input for the one of the process steps.

16. The system of claim 12, wherein the spiral navigation module is further configured to cause an indication of the received user input for the one of the process steps to be displayed in a central location around which the spiral formation of the process step identifiers is disposed.

17. The system of claim 12, wherein the spiral navigation module is further configured to:
receive a user selection of the process step identifier corresponding to the one of the process steps;
cause a user interface element to be displayed, wherein the user interface element is separate from the corresponding process step identifier and is configured to receive user input for the one of the process steps; and
receive the user input via the user interface element.

18. The system of claim 17, wherein the spiral navigation module is configured to cause the user interface element to be displayed on a separate page as the corresponding process step identifier.

19. The system of claim 12, wherein receiving user input for one of the process steps comprises receiving the user input via a user interface element integrated into the corresponding process step identifier.

20. A non-transitory machine-readable storage device, tangibly embodying a set of instructions that, when executed by at least one processor, causes the at least one processor to perform a set of operations comprising:
causing, by a machine having a memory and a processor, a plurality of process step identifiers to be displayed in a spiral formation in a graphical user interface of a device, each process step identifier identifying a corresponding process step of a guided procedure, the process step identifiers being displayed in positions along the spiral formation that reflect an order of their corresponding process steps in the guided procedure;
receiving a user input for one of the process steps of the guided procedure using the process step identifier that corresponds to the one of the process steps for which the user input is received; and
causing the plurality of process step identifiers to be rotated within the graphical user interface of the device.
